(19) United States
(12) Patent Application Publication
(10) Pub. No.: US 2002/0028272 A1
(43) Pub. Date: Mar. 7, 2002

(54) Process of producing enriched vegetable oils

(76) Inventors: Wolfram Junghanns, Gross Schierstedt (DE); Engelbert Grzeschik, Kroppenstedt (DE); Rainer Piela, Sommerschenburg (DE)

Correspondence Address: Law Offices of Karl Hormann, 86 Sparks Street, Cambridge, MA, 02138-2216, US

(21) Appl. No.: 09/917,038

(22) Filed: Jul. 27, 2001

(30) Foreign Application Priority Data
Jul. 20, 2000 (DE) 100 02 220.0
Jan. 16, 2001 (DE) 101 01 638.7

(51) Int. Cl. A23D 7/00

(52) U.S. Cl. 426/417; 554/8; 426/489

(57) ABSTRACT

A process of producing a vegetable oil enriched by an essential oil by mixing and simultaneous cold-pressing of predetermined proportions of prepared hulled oilseeds and parts of plants containing the essential oil followed by removal of the expeller cake and filtering of the extract.

### BACKGROUND OF THE INVENTION

1. Field of the Invention

The invention, in general, relates to a novel process of producing enriched vegetable oils and, more particularly, to a process of producing such oils from various oil-bearing or oleaginous seeds with admixed additives, by pressing and subsequent filtering, for medicinal, cosmetic and nutritional purposes.

2. The Prior Art

Processes of producing vegetable oils from oil-bearing or oleaginous seeds, hereinafter referred to as “oilseeds”, are generally as well known as is the equipment for producing vegetable oils for use in various applications. Such vegetable oils are being used in the fields of medicine, cosmetics and nutrition.

In recent years, people's attitude in respect of vegetable products for use in medicine and cosmetics has undergone a significant change. The demand for natural products has markedly increased as is evident from consumers' changed nutritional habits and from the demand for edible oils not only in the state in which they are derived from their raw materials, but also for vegetable-based edible oils with predetermined flavor components.

German patent specification 41 25 415 discloses a process of producing salad oil in which a mixture of a certain ratio by weight of an oil or fat produced from palm oil or grease and a liquid edible oil is subjected to reesterification with immobilized esterase (lipase) of a specificity of 1.3 in the absence of any solvents. The product is subsequently fractionated in the absence of solvents. In this manner, it is said that a salad oil may be produced from a solid palm oil, with the relative proportion of starter material derived from palm oil being allegedly higher in the salad oil than it would be if made by conventional processes. Furthermore, the salad oil obtained in this manner is said to be of higher cooling stability than salad oils made by conventional processes.

A mixture consisting of (A) an oil or fat made from palm oil and having the following properties

| | |
|---|---|
| iodine number: | 55 to 75; |
| palmitinic acid: | 30 to 42% by weight; |
| linolic acid: | 11 to 20% by weight; |
| tripalmitin: | 2% by weight or less; |
| melting point in an open tube: | 5 to 25° C. |

is mixed with (B) a liquid edible oil different from (A) at a weight ratio of between 5:95 and 95:5. The mixture is subsequently fractionated.

Furthermore, the used oil components may be refined, bleached or deodorized oils, the primary object and aim of the known methods being to raise the cooling stability of such salad oils.

The major problem which besets the prior art process is the high degree of complexity in terms of the operation as well as equipment. Also, the known processes are primarily chemical processes which always leave open the possibility of substances hazardous to health being initially introduced into the oil which must then be removed by complicated follow-up processes. In addition, the reesterification process of German patent specification 41 25 415 requires high operating temperatures and long cooling periods.

German patent specification 31 25 559 C1 and U.S. Pat. No. 5,725,900 issued Mar. 10, 1998 to de Sadeleer et al. disclose mixtures of different oilseeds, among others sunflower, rape and sesame seed which are pressed, together with wheat germ, to extract oil and to add herbs or spices. It is also known to mix essential oils derived from plants with a flotation oil such as wheat germ oil or grape-seed oil.

### OBJECTS OF THE INVENTION.

It is a general object of the present invention to provide a process of producing enriched vegetable oils from various oilseeds which are useful for medicinal, cosmetic and nutritional purposes.

Another object is to provide a process of producing vegetable oils enriched by essential oils of other plants.

A more specific object of the invention is to provide a method of simultaneously extracting oil and essential oils from a mixture of oilseeds and parts of plants containing such essential oils.

A more specific object of the invention is to provide a method of the kind referred to which is not beset by the problems or disadvantages of the prior art.

### BRIEF SUMMARY OF THE INVENTION.

In accordance with the invention, the objects are accomplished by a method of producing enriched vegetable oils suitable for medicinal, cosmetic and nutritional purposes and extracted by the pressing of various oilseeds and admixed additives and including the steps of mixing and cold-pressing prepared hulled oilseeds with parts of spice plants, medicinal plants, fragrant plants and flavoring plants with a moisture content of <15% and granular size between about 1 to 20 mm in weight ratios in the range of 99.9:0.1% and 50:50%, combining the characteristic ingredients removed from the cells of the plant parts with the oil released simultaneously from the oilseeds, separating the oil from the expeller cake and filtering of the oil.

Other objects of the invention will in part be obvious and will in part appear hereinafter.

### DETAILED DESCRIPTION OF THE PREFERRED EMBODIMENTS

The operational sequence for producing enriched oils of the kind referred to is preferably selected such that the used product or raw material is only compressed to a limited degree and is pressed at low temperatures so that the basic consistency of the valuable characteristic ingredients of the spice, medicinal, fragrant or flavoring plants remains unchanged and as defining components determine the characteristic of the derived vegetable oil. Thus, the spice plants determine the fragrance, taste as well as color, and by admixing predetermined proportions of the spice plants relative to the oilseeds, the desired fragrance, taste and color may be varied.

The produced edible vegetable oils positively affect healthful human nutrition and they improve well-being.

This is true also of vegetable oils produced by the proposed method for use as medicinal oils since the basic quality of the ingredients of the medicinal plants remains substantially unchanged as health-promoting ingredients of the produced oil.

Vegetable oils enriched in the manner here described are also of interest to the pharmaceutical and cosmetics industries, as in cosmetics in particular, fragrant and aromatic plants are being used, the ingredients of which also remain unaltered and when used may unfold their full effect.

An essential advantage of the proposed process is the fact that the vegetable oils are produced enriched by quality-determining ingredients from plant cells of spice, medicinal, fragrant and aromatic plants, by a sequence of steps free of the detrimental effects otherwise resulting from chemical and high temperature processes.

The sequence of steps is initiated by mixing the basic materials, i.e. seeds from various plants, such as, for instance, sunflower and rape, with spice, medicinal, fragrant or aromatic plants. The mixture is thereafter compacted and pressed.

The level of pressure exerted is such that while it does lead to breaking open or rupturing the plant cells it does not destroy them. At the same time, the operating temperature is kept at a level which ensures that no thermal damage results.

It is important to mix oilseeds and spice, medicinal, fragrance or flavor plants at a certain weight ratio, to separate the extracted oil from the expeller cake following the pressing operation and thereafter to purify the oil by subjecting it to filtration. Oilseeds which have been found useful in practicing the invention are hulled sunflower kernels, hulled rape as well as hulled sesame.

Spice plants which may be used in practicing the invention are, for example, the twigs and leaves of basil, thyme, marjoram, oregano, tarragon, parsley, dill, dried onions and garlic. Other plants may be used as desired as the invention is not limited to the mentioned spices.

In the production of enriched vegetable oils for medicinal use, medicinal plants such as, for instance, camomile (anthemis nobilis), Saint-John's-wort, marigold, peppermint, balm, artichoke and thyme may be used. Parts of any other plants known for their therapeutic value may be used as well.

Chopped or shredded parts of fragrant or aromatic plants such as, for instance, roses, lavender, violets, jasmine, vanilla, iris root, camomile (flores chamomilla) and others may be used for the production of scented or fragrant enriched vegetable oils.

The plant parts are shredded or chopped to pieces in the order of 1 to 20 mm and are mixed with the oilseeds at a predetermined ratio by weight preferably in the range of from 99.9:0.1 to 50:50.

Following mixing of the shredded or chopped plant parts with the prepared oilseeds, the mixture may be cold-presses in an oil press, for instance, such that its enthalpy, i.e. temperature as a result of the exerted pressure, does not exceed 60° C. The flow conditions generated in the cylinder of the oil press cause the oil extracted from the oilseeds to be repressed at the nozzle aperture of the oil press thus washing the oil soluble ingredients from the plant material. Advantageously, the compression cylinder of the oil press is encased by a container for receiving the oil and protecting it from detrimental ambient effects such as the oxygen in the air and especially for preventing escape of the highly volatile ingredients or essential oils.

A vegetable oil produced in this manner is distinguished from conventionally produced scented or flavored oils by the fact that its fatty acid spectrum of the oilseeds used and their inherent vitamins are preserved and that, in addition, any essential oils, flavonoids, beta-carotene, pigments, phyto-phenols and tannin from those used plants which contain no fatty oil are connected or bonded to the produced vegetable oil.

Moreover, the novel method is distinguished by the fact that the plant components used may be dried pomace from fruit processing and dried berries, the ingredients of which may be integrated in the produced vegetable oil.

The proportion of dissolved ingredients is substantially higher in the vegetable oils produced by the process in accordance with the invention than can be achieved by known maceration processes. Moreover, the novel process is faster and more selective than known processes, and it may be executed at a significantly lower financial investment.

The invention will hereinafter be described in greater detail with reference to specific examples.

A.) The production of enriched vegetable oils for nutritional purposes:

### EXAMPLE 1

Hulled sunflower kernels are mixed with shredded and dried stalks and leaves of marjoram containing about 2% of essential oils at a ratio of about 95:5 percent by weight. The mixture is then cold-pressed and the resultant vegetable oil is filtered. The result is a vegetable salad oil based upon marjoram. The moisture content of the marjoram is less than 10%.

### EXAMPLE 2

Prepared hulled sunflower kernels are mixed with prepared parts of basil shredded to pieces between 5 and 10 mm at a ratio of about 95: 5% by weight. The content of essential oil of the basil is between 1 and 2% and the moisture content is <10%.

### EXAMPLE 3

In a manner analogous to Example 2, 6 to 8% by weight of thyme having an essential oil content of 2 to 3% is mixed with prepared oilseed and after processing the final product is a vegetable oil on a thyme base.

### EXAMPLE 4

8 to 10% by weight of tarragon shredded to pieces of about 10 mm is mixed with the prepared oilseeds. The content of essential oil of the tarragon is about 2% and imparts to the resultant vegetable oil its defining flavor.

### EXAMPLE 5

Garlic shredded to pieces between 5 and 10 mm and having a moisture content of less than 10% is mixed with prepared oilseeds. The mixture is cold-pressed, and as a result of the pressing operation the essential oils of the garlic, being between 3 and 5%, are integrated in the cold-pressed vegetable oil.

B.) The production of enriched vegetable oils for cosmetic purposes.

### EXAMPLE 1

Hulled and prepared oilseed are mixed with shredded and dried leaves of roses in a ratio of 98.5:1.5% by weight. The mixture is cold-presses and the resultant extract is filtered, yielding a rose-scented vegetable oil.

### EXAMPLE 2

Shredded and dried parts of violets are mixed with oilseeds at a ratio of 97.5:2.5% by weight. The mixture is pressed and the extract is filtered yielding a violet-scented vegetable oil.

C.) The production of enriched vegetable oils for medicinal purposes.

### EXAMPLE 1

Hulled kernels of sunflowers, rape or sesame are mixed with shredded parts of camomile (anthemis nobilis) at a ratio 98: 2% by weight. The mixture is then cold-pressed and subsequently filtered yield a camomile based vegetable oil.

### EXAMPLE 2

Thyme, being a spice as well as a medicinal plant, is mixed with prepared oilseeds at a ratio of about 94: 6% by weight. The thyme contains 2 to 3% of essential oils. The mixture is cold-pressed, and the extracted oil is filtered yielding a thyme-based vegetable oil suitable for medicinal purposes.

The selective control of the process and predetermined mixing ratios of oilseeds and parts of spice, medicinal, fragrance and flavor plants used lead to vegetable oils of different degrees of enrichment which may not necessarily be used directly as end products but, rather, as a concentrate as the initial product for further processes or products. This is not only of importance in cosmetics and medicine but also in food stuffs.

The following is an example of a vegetable oil with a high degree of enrichment for use in cosmetics, for instance, in the manufacture of soap: Prepared and hulled kernels of sunflowers, rape or sesame are mixed with shredded parts of lavender at a ratio of 70:30% by weight. The mixture is cold-pressed and the resultant extract is filtered after removal of the expeller cake.

The following is an example of a highly enriched vegetable oil for nutritional purposes: Prepared an hulled sunflower kernels are mixed with dried and shredded parts of basil at a ratio of about 65: 35% by weight. The basil shreds measure between 5 and 10 mm and have a moisture content of less than 10%.

When used with Saint-John's-wort, prepared oilseeds are mixed with shredded Saint-John's-wort at a ratio of about 65:35% by weight, and following cold-pressing and filtering, the resultant product is an intermediate product for use in the manufacture of vegetable oils useful for medicinal purposes.

As regards the process and the described examples, it is important that the used oilseeds and shredded plant parts be thoroughly intermixed, that during the mixing process they are compacted at low temperatures and, thereafter, cold-presses. This leads to release of the ingredients from the cells of the plant parts and their integration in the oil simultaneously released from the oilseeds. Thereafter and before being subjected to filtering, the resultant extract or oil is separated from the expeller cake. It is of particular importance that the parts of the plants be integrated in the process in the state in which they were grown.

It will thus be seen that the invention provides for a process of producing enriched vegetable oils in which the oilseeds and parts of spice, medicinal, fragrance and aroma plants are intermixed for subsequent simultaneous cold-pressing.

What is claimed is:

1. A process of producing a vegetable oil enriched by an essential oil from at least one plant, comprising the steps of:
providing prepared and hulled oilseed;
providing parts of a plant containing an essential oil;
mixing the oilseed and the parts of a plant at a predetermined ratio by weight;
subjecting the mixed oilseeds and arts of a plant to cold-pressing to extract therefrom a vegetable oil with an integrated essential oil component; and
filtering the extracted oil and essential oil component.

2. The process of claim 1, wherein the oilseed and parts of a plant are mixed at a ratio of between 99.9:0.1 and 50:50% by weight.

3. The process of claim 2, wherein the moisture content of the parts of a plant is less than 15%.

4. The process of claim 3, wherein the cold-pressing results in an expeller cake.

5. The process of claim 4, further including the step of removing the expeller cake prior to the filtering.

6. The process of claim 1, wherein the cold-pressing step is executed such that the enthalpy does not exceed 60° C.

7. The process of claim 1, wherein the oilseeds comprise at least one of sunflower, rape and sesame kernels.

8. The process of claim 1, wherein the parts of a plant are from at least one of spice, medicinal, fragrance and flavoring plants.

9. The process of claim 8, wherein the spice plant is at least one of basil, thyme, marjoram, oregano, tarragon, parsley, dill dried onion and garlic.

10. The process of claim 8, wherein the medicinal plant is at least one of camomile (anthemis nobilis), Saint-John's-wort, marigold, peppermint, balm, artichoke and thyme.

11. The process of claim 8, wherein the fragrance plant is at least one of rose, lavender, violet, jasmine, vanilla, iris root, camomile (flores chamomilla).
